(19) United States
(12) Patent Application Publication
(10) Pub. No.: US 2017/0164407 A1
(43) Pub. Date: Jun. 8, 2017

(54) METHOD FOR TRANSMITTING AND RECEIVING CONTROL INFORMATION FOR BROADCAST MULTICAST SERVICE, AND DEVICE THEREFOR

(71) Applicant: LG ELECTRONICS INC., Seoul (KR)

(72) Inventors: Suckchel YANG, Seoul (KR); Joonkui AHN, Seoul (KR)

(73) Assignee: LG ELECTRONICS INC., Seoul (KR)

(21) Appl. No.: 15/316,023

(22) PCT Filed: Jun. 26, 2015
(86) PCT No.: PCT/KR2015/006568

§ 371 Date: Dec. 2, 2016

Related U.S. Application Data
(60) Provisional application No. 62/017,269, filed on Jun. 26, 2014.

(51) Int. Cl. H04W 74/08; H04W 28/06; H04W 48/16

(52) U.S. Cl. CPC H04W 74/0833; H04W 74/0891; H04W 48/16; H04W 28/06

(57) ABSTRACT

The present invention relates to a method for receiving control information for a multimedia broadcast service (MBMS) in a wireless communication system supporting the carrier aggregation among a plurality of cells including a first cell and a second cell, and a device therefor. More specifically, the present invention relates to a method comprising the steps of: receiving information for multicast broadcast single frequency network (MBSFN) configuration through upper layer signaling, wherein the information includes information indicating an MBSFN subframe, information indicating subframes of a first group within the MBSFN subframe, and information indicating subframes of a second group within the MBSFN subframe; receiving multicast control channel (MCCH) information, which has been updated through a physical multicast channel (PMCH), on the first cell when a PDCCH for notifying of a change in a MCCH is received in one subframe among the subframes of the first group on the first cell; and receiving MCCH information, which has been updated through the PMCH, on the second cell when the PDCCH for notifying of the change in the MCCH is received in one subframe among the subframes of the second group on the first cell, and the device therefor.

### TECHNICAL FIELD

The present invention relates to a wireless communication system. More specifically, the present invention relates to a method and apparatus for transmitting and receiving control information for a broadcast multicast service in a wireless communication system where a plurality of cells are aggregated.

### BACKGROUND ART

Wireless communication systems are widely developed to provide various kinds of communication services including audio communications, data communications and the like. Generally, a wireless communication system is a kind of a multiple access system capable of supporting communications with multiple users by sharing available system resources (e.g., bandwidth, transmission power, etc.). For instance, multiple access systems include CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

### DISCLOSURE OF THE INVENTION

### Technical Tasks

An object of the present invention is to provide a method for efficiently transmitting or receiving a signal in a wireless communication system and an apparatus therefor.

Another object of the present invention is to provide a method for efficiently transmitting or receiving a change notification of control information for a broadcast multicast service and updated control information in a wireless communication system in which a plurality of cells are carrier-aggregated and an apparatus therefor.

The other object of the present invention is to provide a method for efficiently transmitting or receiving a change notification of control information for a broadcast multicast service and updated control information on an identical cell in a wireless communication system in which a plurality of cells are carrier-aggregated and an apparatus therefor.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

In an aspect of the present invention, provided herein is a method for receiving control information for MBMS (Multimedia Broadcast Multicast Service) in a wireless communication system supporting carrier aggregation of a plurality of cells comprising a first cell and a second cell, the method comprising: receiving information for MBSFN (Multicast Broadcast Single Frequency Network) configuration via higher layer signaling, wherein the information comprises information indicating MBSFN subframes, information indicating a first group of subframes within the MBSFN subframes, and information indicating a second group of subframes within the MBSFN subframes; when a PDCCH for notifying a change of an MCCH (Multicast Control Channel) is received in one subframe of the first group of subframes on the first cell, receiving updated MCCH information via a PMCH (Physical Multicast Channel) on the first cell; and when a PDCCH for notifying a change of an MCCH is received in one subframe of the second group of subframes on the first cell, receiving updated MCCH information via PMCH on the second cell.

In another aspect of the present invention, provided herein is a user equipment operating in a wireless communication system supporting carrier aggregation of a plurality of cells comprising a first cell and a second cell, the user equipment comprising: an RF (radio frequency) unit; and a processor operably connected to the RF unit and configured to: control the RF unit to receive information for MBSFN (Multicast Broadcast Single Frequency Network) configuration via higher layer signaling, wherein the information comprises information indicating MBSFN subframes, information indicating a first group of subframes within the MBSFN subframes, and information indicating a second group of subframes within the MBSFN subframes, when a PDCCH for notifying a change of an MCCH (Multicast Control Channel) is received in one subframe of the first group of subframes on the first cell, control the RF unit to receive updated MCCH information via a PMCH (Physical Multicast Channel) on the first cell, and when a PDCCH for notifying a change of an MCCH is received in one subframe of the second group of subframes on the first cell, control the RF unit to receive updated MCCH information via a PMCH on the second cell.

Preferably, the plurality of cells further comprise a third cell, the information for MBSFN configuration further comprises information indicating a third group of subframes within the MBSFN subframes, and the method further comprises: when a PDCCH for notifying a change of an MCCH is received in one subframe of the third group of subframes on the first cell, receiving data via a PMCH on the third cell.

Preferably, the PDCCH received on the first cell and the PDCCH received on the second cell are scrambled using different MBMS-specific identification information.

Preferably, the updated MCCH information comprises an RRC (Radio Resource Configuration) message for configuring a single MBSFN region, and the RRC message comprises a list of all MBMS services in progress.

Preferably, the PDCCH is periodically and repeatedly transmitted with a second period in a first period.

Preferably, when the wireless communication system operates in FDD (Frequency Division Duplex), the MBSFN subframes are configured from among subframes other than subframes 0, 4, 5, and 9 in a radio frame, and when the wireless communication system operates in TDD (Time Division Duplex), the MBSFN subframes are configured from among subframes other than subframes 0, 1, 2, 5, and 6 in a radio frame.

### Advantageous Effects

According to the present invention, it is able to efficiently transmit or receive a signal in a wireless communication system.

According to the present invention, it is able to efficiently transmit or receive a change notification of control information for a broadcast multicast service and updated control information on a different cell in a wireless communication system in which a plurality of cells are carrier-aggregated.

According to the present invention, it is able to efficiently transmit or receive a change notification of control information for a broadcast multicast service and updated control information on an identical cell in a wireless communication system in which a plurality of cells are carrier-aggregated.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 illustrates layers of a radio protocol.

FIG. 2 illustrates physical channels and a general method for transmitting signals on the physical channels in the LTE(-A) system.

FIG. 3 illustrates a structure of a radio frame used in the LTE(-A) system.

FIG. 4 illustrates a resource grid of one downlink slot.

FIG. 5 illustrates a downlink subframe structure.

FIG. 6 illustrates configuration of subframes for MBSFN.

FIG. 7 illustrates the structure of an MBSFN subframe.

FIG. 8 illustrates a procedure for MCCH change notification.

FIG. 9 illustrates an example of a carrier aggregation (CA) communication system.

FIGS. 11 to 15 illustrate flowcharts of methods for receiving control information for a broadcast/multicast service according to the present invention.

FIG. 16 is a diagram illustrating a base station and a user equipment to which the present invention is applicable.

### MODE FOR INVENTION

The following embodiments of the present invention may be applied to a variety of wireless access technologies such as code division multiple access (CDMA), frequency division multiple access (FDMA), time division multiple access (TDMA), orthogonal frequency division multiple access (OFDMA), single carrier frequency division multiple access (SC-FDMA), and the like. CDMA may be embodied through wireless (or radio) technology such as universal terrestrial radio access (UTRA) or CDMA2000. TDMA may be embodied through wireless (or radio) technology such as global system for mobile communication (GSM)/general packet radio service (GPRS)/enhanced data rates for GSM evolution (EDGE). OFDMA may be implemented by wireless (or radio) technology such as Institute of Electrical and Electronics Engineers (IEEE) 802.11 (Wi-Fi), IEEE 802.16 (WiMAX), IEEE 802-20, and evolved UTRA (E-UTRA). UTRA is a part of universal mobile telecommunications system (UMTS). 3^{rd} generation partnership project (3GPP) long term evolution (LTE) is a part of E-UMTS (Evolved UMTS), which uses E-UTRA. LTE-Advanced (LTE-A) is an evolved version of 3GPP LTE.

For clarity of explanations, the following description focuses on 3GPP LTE(-A) system. However, technical features of the present invention are not limited thereto. Further, a particular terminology is provided for better understanding of the present invention. However, such a particular terminology may be changed without departing from the technical spirit of the present invention. For example, the present invention may be applied to a system in accordance with a 3GPP LTE/LTE-A system as well as a system in accordance with another 3GPP standard, IEEE 802.xx standard, or 3GPP2 standard.

In a wireless access system, a UE may receive information from a BS in downlink (DL) and transmit information in uplink (UL). The information transmitted or received by the UE may include data and various control information. In addition, there are various physical channels according to the type or use of the information transmitted or received by the UE.

In the present invention, a base station (BS) generally refers to a fixed station that performs communication with a UE and/or another BS, and exchanges various kinds of data and control information with the UE and another BS. The base station (BS) may be referred to as an advanced base station (ABS), a node-B (NB), an evolved node-B (eNB), a base transceiver system (BTS), an access point (AP), a processing server (PS), a transmission point (TP), etc. In the present invention, a BS may be interchangeably referred to as an eNB.

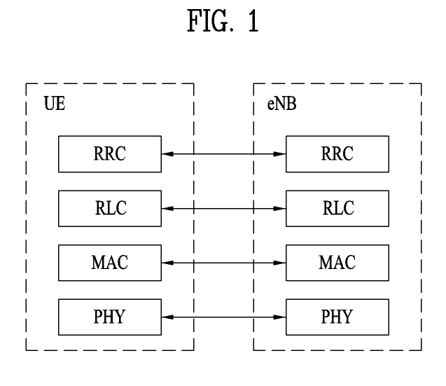

FIG. 1 illustrates layers of a radio protocol.

The physical layer (PHY) which is a first layer provides information transfer services to the upper layers using a physical channel. The PHY layer is connected to the upper medium access control (MAC) layer through a transport channel, and data between the MAC layer and the PHY layer is transferred through the transport channel. In this case, the transport channel is roughly divided into a dedicated transport channel and a common transport channel based on whether or not the channel is shared. Furthermore, data is transferred between different PHY layers, i.e., between PHY layers at transmitter and receiver sides.

A second layer may include various layers. The medium access control (MAC) layer serves to map various logical channels to various transport channels, and also performs logical channel multiplexing for mapping several logical channels to one transport channel. The MAC layer is connected to a radio link control (RLC) layer, which is an upper layer, through a logical channel, and the logical channel is roughly divided into a control channel for transmitting control plane information and a traffic channel for transmitting user plane information according to the type of information to be transmitted.

The RLC layer of the second layer manages segmentation and concatenation of data received from an upper layer to appropriately adjusts a data size such that a lower layer can send data to a radio section. Also, the RLC layer provides three operation modes such as a Transparent Mode (TM), an Un-acknowledged Mode (UM), and an Acknowledged Mode (AM) so as to guarantee various Quality of Services (QoS) required by each Radio Bearer (RB). In particular, AM RLC performs a retransmission function through an ARQ function for reliable data transmission.

A radio resource control (RRC) layer located at the uppermost portion of a third layer is only defined in the control plane. The RRC layer performs a role of controlling logical channels, transport channels, and physical channels in relation to configuration, re-configuration, and release of radio bearers. Here, the radio bearer denotes a logical path provided by the first and the second layers for transferring data between the UE and the UTRAN. In general, the configuration of the radio bearer refers to a process of stipulating the characteristics of protocol layers and channels required for providing a specific service, and setting each of the detailed parameter and operation methods thereof. The radio bearer is divided into a signaling radio bearer (SRB) and a data radio bearer (DRB), wherein the SRB is used as a path for transmitting RRC messages in the control plane while the DRB is used as a path for transmitting user data in the user plane.

In a wireless access system, a user equipment (UE) may receive information from a base station (BS) in downlink (DL) and transmit information in uplink (UL). The information transmitted or received by the UE may include general data information and various control information. In addition, there are various physical channels according to the type or use of the information transmitted or received by the UE.

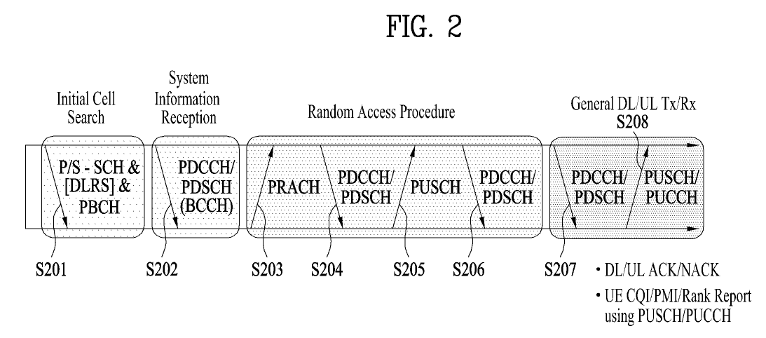

FIG. 2 illustrates physical channels and a general method for transmitting signals on the physical channels in the LTE(-A) system.

When a UE is powered on or enters a new cell, the UE performs initial cell search in step S201. The initial cell search involves acquisition of synchronization to a base station. To this end, the UE synchronizes its timing to the base station and acquires information such as a cell identifier (ID) by receiving a primary synchronization channel (P-SCH) and a secondary synchronization channel (S-SCH) from the base station. Then the UE may acquire broadcast information in the cell by receiving a physical broadcast channel (PBCH) from the base station. During the initial cell search, the UE may monitor a DL channel state by receiving a downlink reference signal (DL RS).

After the initial cell search, the UE may acquire more detailed system information by receiving a physical downlink control channel (PDCCH) and receiving a physical downlink shared channel (PDSCH) based on information of the PDCCH in step S202.

To complete access to the base station, the UE may perform a random access procedure such as steps S203 to S206 with the base station. To this end, the UE may transmit a preamble on a physical random access channel (PRACH) (S203) and may receive a response message to the preamble on a PDCCH and a PDSCH associated with the PDCCH (S204). In the case of a contention-based random access, the UE may additionally perform a contention resolution procedure including transmission of an additional PRACH (S205) and reception of a PDCCH signal and a PDSCH signal corresponding to the PDCCH signal (S206).

After the above procedure, the UE may receive a PDCCH and/or a PDSCH from the base station (S207) and transmit a physical uplink shared channel (PUSCH) and/or a physical uplink control channel (PUCCH) to the base station (S208), in a general UL/DL signal transmission procedure. Information that the UE transmits to the base station is referred to as Uplink Control Information (UCI). The UCI includes hybrid automatic repeat and request acknowledgement/negative acknowledgement (HARQ-ACK/NACK), scheduling request (SR), channel state information (CSI), etc. The CSI includes channel quality indicator (CQI), precoding matrix indicator (PMI), rank indication (RI), etc. UCI is generally transmitted on a PUCCH periodically. However, if control information and traffic data should be transmitted simultaneously, or if a data transmission is configured at the time of a UCI transmission, they may be transmitted on a PUSCH. In addition, the UCI may be transmitted aperiodically on the PUSCH, upon receipt of a request/command from a network.

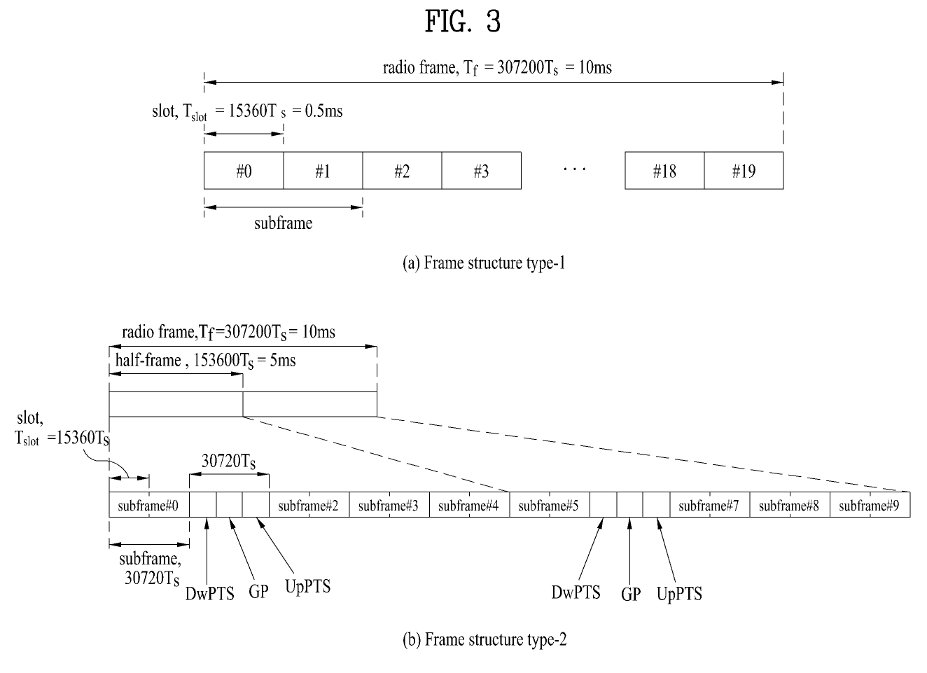

FIG. 3 illustrates a structure of a radio frame used in the LTE(-A) system. In a cellular OFDM radio packet communication system, uplink/downlink data packet transmission is performed in the unit of a subframe (SF), and one subframe is defined as a predetermined duration including a plurality of OFDM symbols. The LTE(-A) system supports a type-1 radio frame structure applicable to frequency division duplex (FDD) and a type-2 radio frame structure applicable to time division duplex (TDD).

FIG. 3(a) shows the structure of the type-1 radio frame. A downlink radio frame includes 10 subframes and one subframe includes two slots in a time domain. A time required to transmit one subframe is referred to as a transmission time interval (TTI). For example, one subframe has a length of 1 ms and one slot has a length of 0.5 ins. One slot includes a plurality of OFDM symbols in a time domain and includes a plurality of resource blocks (RBs) in a frequency domain. In the LTE(-A) system, since OFDM is used in downlink, an OFDM symbol indicates one symbol duration. In the LTE(-A) system, since SC-FDMA is used in uplink, an OFDM symbol may be referred to as an SC-FDMA symbol in the present specification, and also may be collectively referred to as a symbol duration. A resource block (RB) as a resource assignment unit may include a plurality of consecutive subcarriers in one slot.

The length of one symbol duration (or the number of OFDM symbols included in one slot) may vary according to a configuration of cyclic prefix (CP). The cyclic prefix refers to repeating a portion of symbol (e.g. the last portion of symbol) or the entire symbol and placing the repeated portion in front of the symbol. The cyclic prefix is used to remove inter-symbol interferences or facilitate a channel measurement of frequency-selective multi-path channel. The cyclic prefix includes an extended CP and a normal CP. For example, if OFDM symbols are configured by the normal CP, the number of OFDM symbols included in one slot may be 7. In case of the extended CP, for example, the number of OFDM symbols included in one slot may be 6.

FIG. 3(b) illustrates a structure of the type-2 radio frame. The type-2 radio frame includes two half frames, and each half frame includes five subframes, a downlink period (e.g. a downlink pilot time slot or DwPTS), a guard period (GP) and an uplink period (e.g. an uplink pilot time slot or UpPTS). One subframe includes two slots. For example, The downlink period (e.g., DwPTS) is used for initial cell search, synchronization or channel estimation of a UE. For example, the uplink period (e.g., UpPTS) is used for channel estimation of a BS and uplink transmission synchronization of a UE. For example, the uplink period (e.g., UpPTS) may be used to transmit a sounding reference signal (SRS) for channel estimation in a base station and to transmit a physical random access channel (PRACH) that carriers a random access preamble for uplink transmission synchronization. The guard period is used to eliminate interference generated in uplink due to multi-path delay of a downlink signal between uplink and downlink. Table 1 shows an example of an uplink-downlink (UL-DL) configuration of subframes within a radio frame in a TDD mode.

TABLE 1

| Uplink- | Downlink- | | | | | | | | | | |
|---|---|---|---|---|---|---|---|---|---|---|---|
| downlink | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1 above, D represents a downlink subframe (DL SF), U represents an uplink subframe (UL SF), and S represents a special subframe. The special subframe includes a downlink period (e.g. DwPTS), a guard period (e.g. GP), and an uplink period (e.g. UpPTS). Table 2 shows an example of a special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The above-described radio frame structure is exemplary. Thus, the number of subframes in a radio frame, the number of slots in a subframe, or the number of symbols in a slot may be modified in various ways.

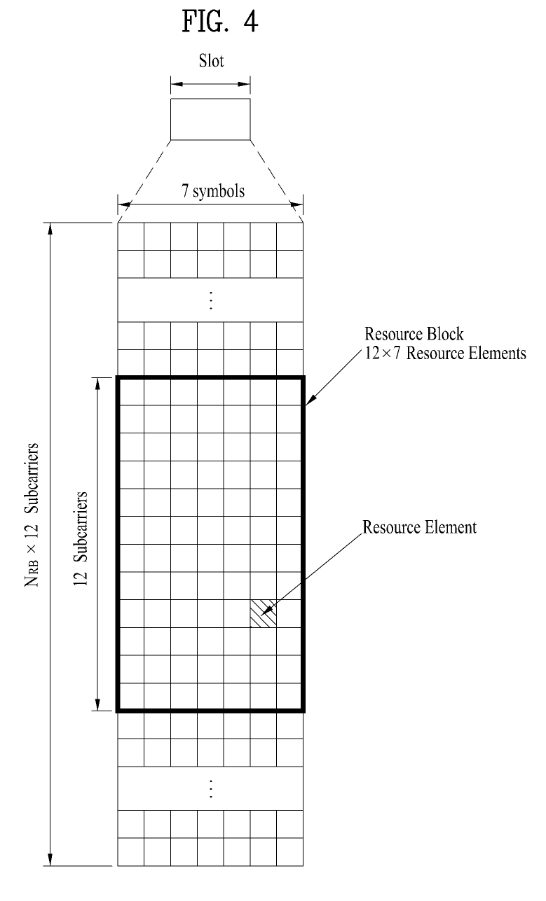

FIG. 4 illustrates a resource grid of one downlink slot.

Referring to FIG. 4, a downlink slot includes a plurality of OFDM symbols in the time domain. One downlink slot may include 7 OFDM symbols and one resource block (RB) may include 12 subcarriers in the frequency domain. An example as illustrated in FIG. 4 may be applied to a normal CP case, while one downlink slot may include 6 OFDM symbols in the time domain in case of an extended CP case. Each element of the resource grid is referred to as a Resource Element (RE). An RB includes 12×7 REs. The number of RBs in a downlink slot, N_{DL} depends on a downlink transmission bandwidth. The structure of an uplink slot may have the same structure as a downlink slot.

FIG. 5 illustrates a downlink subframe structure.

Referring to FIG. 5, a maximum of three (four) OFDM symbols located in a front portion of a first slot within a subframe correspond to a control region to which a control channel is allocated. The remaining OFDM symbols correspond to a data region to which a physical downlink shared chancel (PDSCH) is allocated. A basic resource unit of the data region is RB. Examples of downlink control channels used in the LTE(-A) system include a physical control format indicator channel (PCFICH), a physical downlink control channel (PDCCH), a physical hybrid ARQ indicator channel (PHICH), etc.

PCFICH is transmitted at the first OFDM symbol of a subframe and carries information regarding the number of OFDM symbols used for transmission of control channels within the subframe. The PCFICH is composed of four resource element groups (REGs) each of which is uniformly distributed in a control region based on a cell ID. The PCFICH indicates a value of 1 to 3 (or 2 to 4) and is modulated using quadrature phase shift keying (QPSK).

PDCCH carries a transmission format or resource allocation information of downlink shared channel (DL-SCH), a transmission format or resource allocation information of uplink shared channel (UL-SCH), paging information on paging channel (PCH), system information on DL-SCH, resource allocation information of an upper layer control message such as random access response transmitted on PDSCH, a set of Tx power control commands for individual UEs within a UE group, Tx power control command, activation indication information of Voice over IP (VoIP), etc. The PDCCH is allocated in the first n OFDM symbols (hereinafter, a control region) of a subframe. Here, n is an integer equal to or greater than 1 and is indicated by the PCFICH. Control information transmitted through the PDCCH is referred to as downlink control information (DCI). DCI format is defined as formats 0, 3, 3A, and 4 for uplink and defined as formats 1, 1A, 1B, 1C, 1D, 2, 2A, 2B, 2C, and 2D for downlink. For example, DCI format may selectively include exemplary fields shown in Table 3. In Table 3, a bit size of each information field is a non-limiting example.

TABLE 3

| Field | Bit(s) |
|---|---|
| Flag for determining DCI | 1 |
| format 0/1A | |
| Hopping flag | 1 |
| RB assignment | ┌log ₂ (N_{RB}^{UL} (N_{RB}^{UL} + 1)/2)┐ |
| MCS (Modulation and coding | 5 |
| scheme) and RV (Redundancy | |
| Version) | |
| NDI (New Data Indicator) | 1 |
| TPC (Transmit Power Control) | 2 |
| command for scheduled | |
| PUSCH | |
| Cyclic shift for DM RS | 3 |
| UL index (TDD) | 2 |
| CQI request | 1 |

The flag field is an information field for identifying between DCI format 0 and DCI format 1A. That is, DCI format 0 and DCI format 1A have the same payload size and are identified by the flag field. The bit size of the resource block allocation and hopping resource allocation field may vary according to hopping PUSCH or non-hopping PUSCH. The resource block allocation and hopping resource allocation field for the non-hopping PUSCH provides ┌log₂(N_{RB}^{UL}(N_{RB}^{UL}+1)/2)┐ bits for resource allocation of the first slot in an uplink subframe. Here, N_{RB}^{UL} denotes the number of RBs included in an uplink slot and depends upon an uplink transmission bandwidth set in a cell. Accordingly, the payload size of DCI format 0 may depend upon uplink bandwidth. DCI format 1A includes an information field for PDSCH allocation. The payload size of DCI format 1A may depend upon downlink bandwidth. DCI format 1A provides a reference information bit size for DCI format 0. Accordingly, DCI format 0 is padded with ‘0’ until the payload size of DCI format 0 becomes identical to the payload size of DCI format 1A when the number of information bits of DCI format 0 is less than the number of information bits of DCI format 1A. The added ‘0’ is filled in a padding field of DCI format.

DCI format 1C is used for very compact scheduling of PDSCH or for notifying a change of MCCH (Multicast Control Channel). If DCI format 1C is used for very compact scheduling of one PDSCH, DCI format 1C may comprise a bit indicating a gap value, resource block allocation information, and modulation and coding scheme information. If DCI format 1C is used for MCCH change notification, DCI format 1C may comprise information for MCCH change notification and reserved information bits. The information for MCCH change notification may comprise 8-bit bitmap. Each bit within the 8-bit bitmap indicates a MCCH change for a corresponding MBSFN area. For which MBSFN area each bit of the bitmap is used may be defined by indication information (e.g. notification indicator) received through specific system information (e.g. SystemInformationBlockType13 or SIB13). The reserved bits may be added until the size of DCI format 1C is the same as the size of DCI format 1C used for very compact scheduling of one PDSCH. Thereby, DCI format 1C used for MCCH change notification can have the same size as DCI format 1C used for very compact scheduling of PDSCH.

A base station determines a PDCCH format according to DCI to be transmitted to a UE, and attaches a cyclic redundancy check (CRC) to control information. The CRC is masked with an identifier (e.g. a radio network temporary identifier (RNTI)) according to an owner or usage of the PDCCH. For example, if the PDCCH is for a specific UE, an identifier (e.g., cell-RNTI (C-RNTI)) of the UE may be masked to the CRC. Alternatively, if the PDCCH is for a paging message, a paging identifier (e.g., paging-RNTI (P-RNTI)) may be masked to the CRC. If the PDCCH is for system information (more specifically, a system information block (SIB)), a system information RNTI (SI-RNTI) may be masked to the CRC. When the PDCCH is for a random access response, a random access-RNTI (RA-RNTI) may be masked to the CRC. When he PDCCH is for a broadcast multicast service (e.g. MBMS (Multimedia Broadcast Multicast Service)), M-RNTI (MBMS RNTI) may be masked to the CRC. Masking an RNTI may have the same meaning as scrambling the RNTI.

A plurality of PDCCHs may be transmitted within one subframe. A UE may monitor the plurality of PDCCHs. PDCCH is transmitted on an aggregation of one or several consecutive control channel elements (CCEs). A CCE is a logical allocation unit used to provide the PDCCH with a coding rate based on a state of a radio channel. The CCE corresponds to a plurality of resource element groups (REGs). A format of the PDCCH and the number of bits of the available PDCCH are determined by the number of CCEs. Each PDCCH is transmitted using one or more control channel elements (CCEs) and each CCE corresponds to 9 sets of 4 resource elements. The 4 resource elements are referred to as a resource element group (REG). 4 QPSK symbols are mapped to one REG A resource element allocated to a reference signal is not included in an REG and thus a total number of REGs in a given OFDM symbol varies according to whether a cell-specific reference signal is present.

Table 4 exemplarily shows the number of CCEs, the number of REGs, and the number of PDCCH bits according to PDCCH format.

TABLE 4

| PDCCH | Number of | Number | Number of PDCCH |
|---|---|---|---|
| format | CCE (n) | of REG | bits |
| 0 | 1 | 9 | 72 |
| 1 | 2 | 18 | 144 |
| 2 | 4 | 36 | 288 |
| 3 | 8 | 72 | 576 |

CCEs are consecutively numbered. To simplify a decoding process, transmission of a PDCCH having a format including n CCEs can be started using as many CCEs as a multiple of n. The number of CCEs used to transmit a specific PDCCH is determined by a BS according to channel condition. For example, if a PDCCH is for a UE having a high-quality downlink channel (e.g. a channel close to the BS), only one CCE can be used for PDCCH transmission. However, for a UE having a poor channel (e.g. a channel close to a cell edge), 8 CCEs can be used for PDCCH transmission in order to obtain sufficient robustness. In addition, a power level of the PDCCH can be controlled according to channel condition.

The LTE(-A) system defines a limited set of CCE positions in which a PDCCH is to be positioned for each UE. The limited set of CCE positions that a UE can find a PDCCH of the UE may be referred to as a search space (SS). In the LTE(-A) system, the search space has different sizes according to each PDCCH format. In addition, a UE-specific search space and a common search space are separately defined. The base station does not provide the UE with information indicating where the PDCCH is located in the control region. Accordingly, the UE monitors a set of PDCCH candidates within the subframe and finds its own PDCCH. The term “monitoring” means that the UE attempts to decode the received PDCCHs according to respective DCI formats. The monitoring for a PDCCH in a search space is referred to as blind decoding (or blind detection). Through blind decoding, the UE simultaneously performs identification of the PDCCH transmitted to the UE and decoding of the control information transmitted through the corresponding PDCCH. For example, if a CRC error is not detected when the PDCCH is de-masked using the C-RNTI, the UE has detected its own PDCCH. The UE-specific search space (USS) is separately configured for each UE and a scope of common search space (CSS) is known to all UEs. The USS and the CSS may be overlapped with each other. When a significantly small search space is present, if some CCE positions are allocated in a search space for a specific UE, the remaining CCEs are not present. Thus a base station may not find CCE resources in which the PDCCH is to be transmitted to all available UEs in a given subframe. In order to minimize the possibility that such blocking is subsequent to a next subframe, a start position of the USS is UE-specifically hopped.

Table 5 shows sizes of CSS and USS.

TABLE 5

| PDCCH | Number of | Number of | Number of |
|---|---|---|---|
| format | CCE (n) | candidates in CSS | candidates in USS |
| 0 | 1 | — | 6 |
| 1 | 2 | — | 6 |
| 2 | 4 | 4 | 2 |
| 3 | 8 | 2 | 2 |

To appropriately control computational load of blind decoding, the UE is not required to simultaneously search for all defined DCI formats. In general, the UE always searches for formats 0 and 1A in USS. Formats 0 and 1A have the same size and are discriminated from each other by a flag in a message. The UE may need to receive an additional format (e.g. format 1, 1B or 2 according to PDSCH transmission mode configured by a base station). The UE searches for formats 1A and 1C in CSS. Furthermore, the UE may be configured to search for format 3 or 3A. Formats 3 and 3A have the same size as that of formats 0 and 1A and may be discriminated from each other by scrambling CRC with different (common) identifiers rather than a UE-specific identifier.

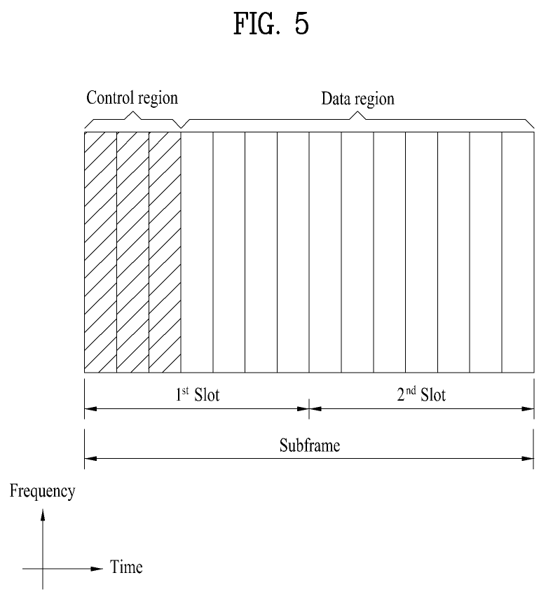

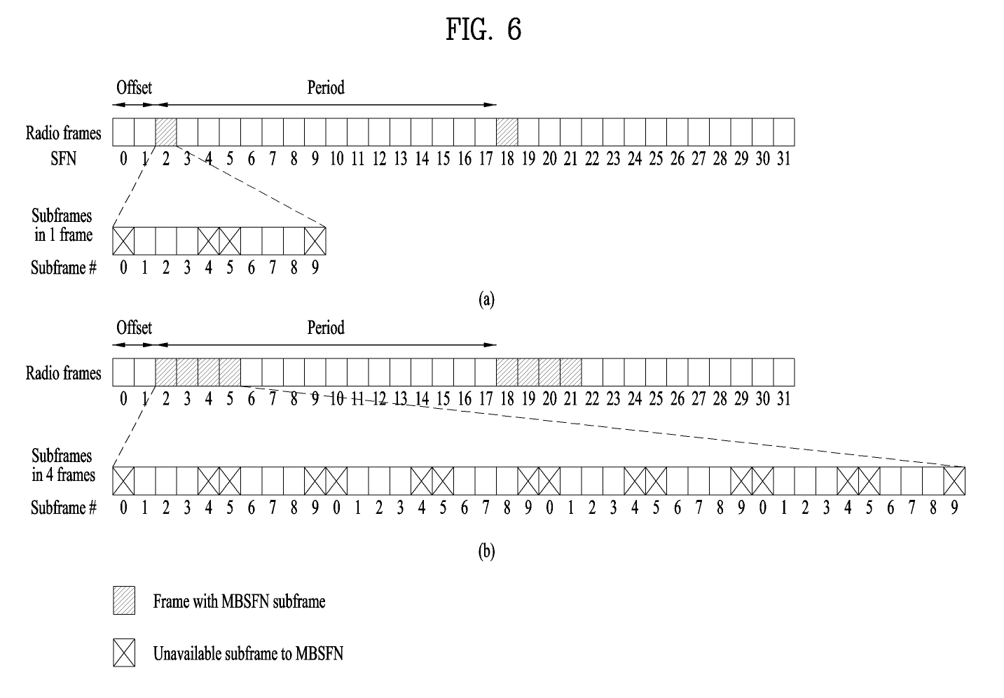

FIG. 6 illustrates configuration of subframes for MBSFN.

In a long term evolution-advanced (LTE-A) system, a multimedia broadcast multicast service single frequency network (MBSFN)-based multimedia broadcast and multimedia service (MBMS) is defined in order to provide a broadcast service over a communication network. An MBSFN is technology for simultaneously transmitting the same data at the same time in all of nodes belonging to an MBSFN area in synchronization with a radio resource. Here, the MB SFN area refers to an area covered by one MBSFN. According to the MBSFN, even when the UE is located at an edge of coverage of a node that the UE has accessed, a signal of a neighboring node functions not as interference but as gain. That is, the MBSFN introduces a single frequency network (SFN) function for MBMS transmission, thereby reducing service interference caused by frequency switching in the middle of MBMS transmission. Therefore, the UE within the MBSFN area recognizes MBMS data transmitted by multiple nodes as data transmitted by one node and in this MBSFN area, the UE may receive a seamless broadcast service without an additional handover procedure even while in motion. In the MBSFN, since a plurality of nodes use a single frequency in order to simultaneously perform synchronized transmission, frequency resources can be saved and spectrum efficiency can be raised.

In order to support MBSFN in the 3GPP LTE-A system, two logical channels, a multicast control channel (MCCH) and a multicast traffic channel (MTCH), are defined. The MCCH is used to transmit control messages of all MBMS services to one MBSFN area and the MTCH is used to transmit session data of one MBMS service. The session data is associated with content of the MBMS service. Both the MCCH and MTCH are mapped to a transport channel called a multicast channel (MCH). The MCH is mapped to a PMCH among physical channels. There may be multiple PMCHs according to characteristics of the MBMS service and the PMCHs are transmitted only in an MB SFN subframe.

MCCH transmitting control information for MBMS is associated with one MBSFN area, and one MCCH corresponds to one MBSFN area. MCCH comprises an RRC message for single MB SFN area configuration and optionally MBMS counting request message. The RRC message lists all MBMS services having sessions in progress. MCCH is transmitted by all cells in an MBSFN area except for MBSFN area reserved cells. MCCH is transmitted by RRC for every repetition period within a modification period. If MCCH is changed, a change notification may be transmitted periodically (e.g. with a MCCCII repetition period) to a UE in a subframe configured for the notification from among MBSFN subframes within the modification period positioned before the MCCH change. As explained above, DCI format 1C masked or scrambled with a specific MBMS RNTI (e.g. M-RNTI) is used for MCCH change notification, and DCI format 1C may comprise an 8-bit bitmap to indicate one or more MBSFN areas where MCCH is changed. If UE receives a change notification, the UE may receive updated MCCH in the boundary of the next MCCH modification period.

A UE may know which subframe is reserved for MBSFN by receiving a higher layer signal (e.g. RRC (Radio Resource Control) message) indicating MBSFN subframes. The higher layer signal defining subframes (referred to as MBSFN subframes) reserved for MBSFN in downlink may comprise information about an allocation period of a radio frame having MBSFN subframes and an allocation offset specifying a start position of the radio frame having MBSFN subframes. Further, the higher layer signal may further comprise information indicating a subframe allocated to MBSFN subframes within a radio frame reserved for MBSFN. A subset of downlink subframes within a radio frame on a component carrier supporting PDSCH transmission may be configured as MBSFN subframes by the higher layer signal. In case of an FDD system, subframes 0, 4, 5, 9 within a radio frame cannot be configured as MBSFN subframes, while subframes 1, 2, 3, 6, 7, 8 can be configured as MBSFN subframes. In case of a TDD system, subframes 0, 1, 2, 5, 6 within a radio frame cannot be configured as MBSFN subframes, while subframes 3, 4, 7, 8, 9 can be configured as MBSFN subframes.

For example, referring to FIG. 6, upon receiving the higher layer signal, the allocation period of which is 8 and the allocation offset of which is 2, the UE may determine that radio frames having system frame numbers (SFNs) satisfying the condition that the result of performing modulo operation of an SFN by allocation period “8” is the allocation offset, 2, include MBSFN subframes. That is, the UE can be aware that an MBSFN subframe is included in a radio frame having an SFN satisfying “SFN mod (period)=offset”. Meanwhile, the higher layer signal includes a 6-bit bitmap corresponding one-to-one to subframe #1, #2, #3, #6, #7, and #8 among subframes #0 to #9 in one radio frame or a 24-bit bitmap corresponding one-to-one to subframe #1, #2, #3, #6, #7, and #8 of each of four consecutive radio frames. The eNB may allocate the PMCH to a subframe set to ‘1’ in the 6-bit bitmap or 24-bit bitmap and transmit an MBSFN service, i.e. an MBMS, on the PMCH in the subframe. The UE may assume that a subframe corresponding to a bit set to ‘1’ in the 6-bit bitmap or 24-bit bitmap is a subframe reserved as the MBSFN and receive the MBMS through the PMCH in the subframe.

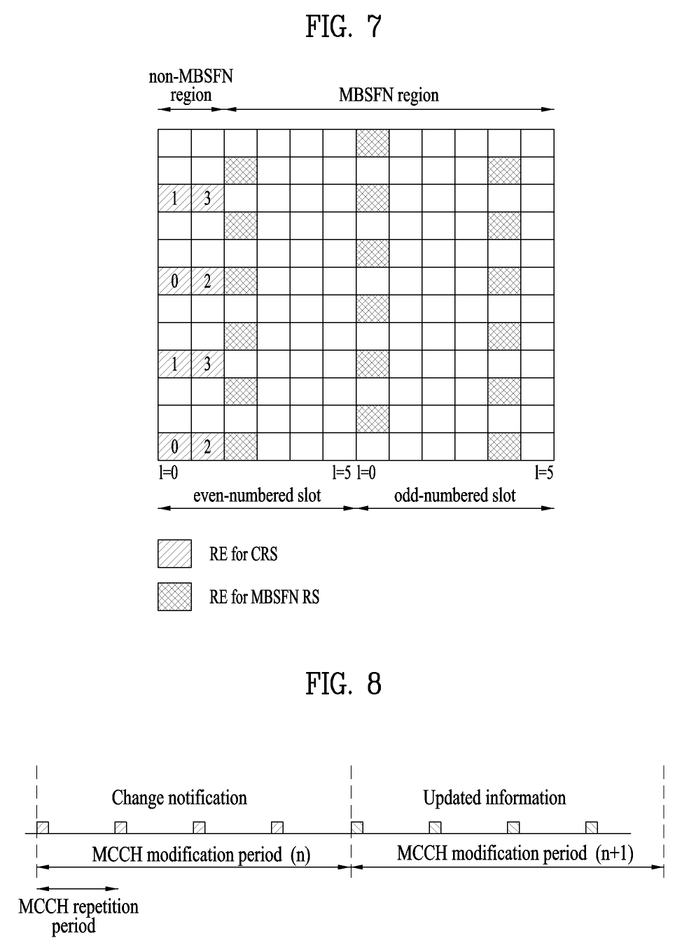

FIG. 7 illustrates the structure of an MBSFN subframe.

Each MB SFN subframe is divided into a non-MB SFN region and an MBSFN region in the time domain. The non-MBSFN region spans one or two front OFDM symbols and the MBSFN region in the MBSFN subframe is defined as OFDM symbols unused for the non-MBSFN region. The length of the non-MB SFN region may be given by Table 6 indicating the number of OFDM symbols which can be used to transmit PDCCH(s). In order to prevent a UE incapable of supporting an MBSFN from recognizing transmission in the MBSFN subframe as an error and to cause the UE to obtain DCI at least in the non-MBSFN region, the same length as the length of a CP used for subframe #0 may be used for transmission in the non-MBSFN region.

TABLE 6

| | Number | Number |
|---|---|---|
| | of OFDM | of OFDM |
| | symbols | symbols |
| | for PDCCH | for PDCCH |
| | when | when |
| Subframe | N_{RB}^{DL} >10 | N_{RB}^{DL} ≦ 10 |
| Subframe 1 and 6 for frame | 1, 2 | 2 |
| structure type 2 | | |
| MBSFN subframes on a carrier | 1, 2 | 2 |
| supporting PDSCH, configured with | | |
| 1 or 2 cell-specific antenna ports | | |
| MBSFN subframes on a carrier | 2 | 2 |
| supporting PDSCH, configured with | | |
| 4 cell-specific antenna ports | | |
| Subframes on a carrier not | 0 | 0 |
| supporting PDSCH | | |
| Non-MBSFN subframes (except | 1, 2, 3 | 2, 3 |
| subframe 6 for frame structure | | |
| type 2) configured with positioning | | |
| reference signals | | |
| All other cases | 1, 2, 3 | 2, 3, 4 |

A PMCH may be transmitted only in the MBSFN region of the MBSFN subframe and uses an extended CP. Therefore, a current MBSFN subframe uses an extended CP and includes 12 OFDM symbols in the case of a subcarrier spacing of Δf=15 kHz.

When a packet is transmitted in a wireless communication system, signal distortion may occur during transmission since the signal is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is referred to as a pilot signal or a reference signal.

Reference signals may be classified into a reference signal for acquiring channel information and a reference signal used for data demodulation. The former is for a UE to acquire channel information in downlink, the reference signal for acquiring channel information is transmitted in wideband, and a UE which does not receive downlink data in a specific subframe receives the reference signal. Further, this reference signal is used in a handover situation. The latter is a reference signal transmitted together when a base station transmits a downlink signal, and enables a UE to demodulate the downlink signal using the reference signal. The reference signal used for data demodulation is required to be transmitted in a data transmission region.

Downlink reference signal includes:

i) a cell-specific reference signal (CRS) shared by all UEs in a cell;

ii) a UE-specific reference signal for a specific UE only;

iii) a demodulation reference signal (DM-RS) transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

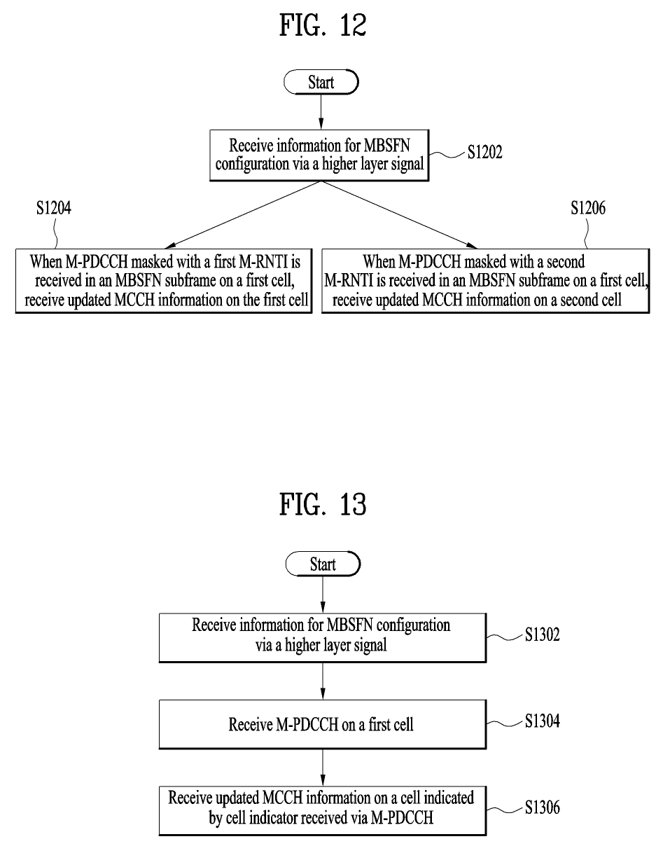

In the MBSFN subframe, a CRS is transmitted only in the non-MB SFN region of the MBSFN subframe. Referring to FIG. 12, if the non-MBSFN region spans the first two OFDM symbols of the MBSFN subframe, the CRS is transmitted only on the first two OFDM symbols. An MBSFN RS may be transmitted in the MBSFN region of the MBSFN subframe. The MBSFN RS may be transmitted over antenna port 4 only when the PMCH is transmitted in the MBSFN subframe. A current MBSFN RS is defined only with respect to the extended CP. CRS is commonly applied in only a specific cell, while MBSFN RS may be commonly applied to one or more cells constructing an MBSFN area.

FIG. 8 illustrates a procedure for MCCH change notification.

In the case that MCCH information is changed, a base station may transmit an MCCH change notification to a UE. The change of MCCH information may occur in a specific radio frame, and the same MCCH information may be repeatedly transmitted to the UE several times within a modification period. The MCCH change notification may be transmitted via a PDCCH masked or scrambled with an MBMS specific RNTI. The MCCH change notification may be periodically transmitted within a specific MCCH modification period, and may be transmitted only within MBSFN subframes.

Referring to FIG. 8, a PDCCH including an MCCH change notification may be periodically and repeatedly transmitted to a UE with an MCCH repetition period within an MCCH modification period n. In this case, the PDCCH may be masked or scrambled with M-RNTI, and may comprise DCI format 1C. Since DCI format 1C is used for the MCCH change notification, as described above, DCI format 1C may comprise an 8-bit bitmap and reserved information bits. In order to indicate which MBSFN area each bit of the 8-bit bitmap corresponds to, a base station may transmit indication information (e.g. notification indicator) to a UE through specific system information (e.g. SIB13). If the UE successfully decodes the PDCCH masked or scrambled with M-RNTI, the UE may recognize whether MCCH is changed for the corresponding MBSFN area based on the bitmap information included in the PDCCH.

In the example of FIG. 8, in the case that a UE receives an MCCH change notification in an MCCH modification period n, the UE may receive updated MCCH information in an MCCH modification period n+1. The MCCH information may be received via a PMCH, and may be periodically and repeatedly received with an MCCH repetition period within the MCCH modification period n+1.

System information for supporting MBSFN is system information block type 13 (or SIB13). SIB13 may be transmitted/received through a logical channel BCCH (Broadcast Control CHannel). BCCH may be mapped to BCH (Broadcast Channel) and be transmitted/received via PBCH (Physical Broadcast Channel), or may be mapped to DL-SCH (Downlink Shared Channel) and transmitted/received through PDSCH (Physical Downlink Shared Channel).

For each MCCH, system information (e.g. SIB13) may comprise the following information.
scheduling of MCCH for multi-cell transmission on MCH
MCCH modification period, repetition period radio frame offset, subframe allocation
subframes indicated for MCCH scheduling in a specific MBSFN area, and MCS applied to the first subframe of every MCH scheduling period

Further, for notifications commonly used for MCCH, system information (e.g. SIB13) may comprise the following information.
configuration information about subframe positions for MCCH change notification and the number of occasions to be monitored by a UE
indication information about mapping relations between bitmap for MCCH change notification and MCCHs

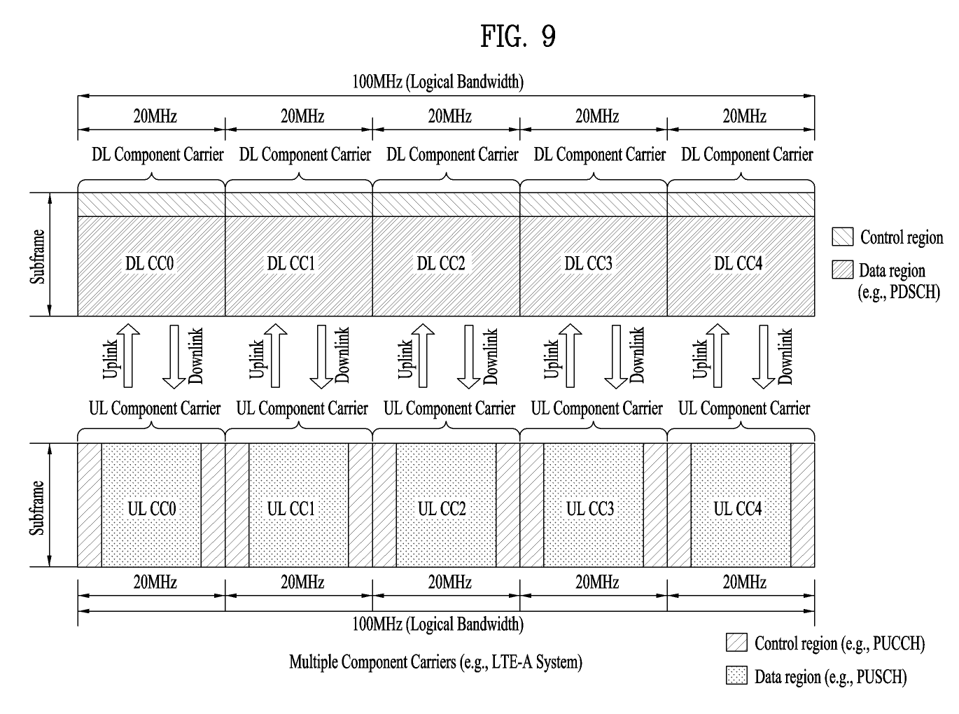

FIG. 9 illustrates an example of a carrier aggregation (CA) communication system.

Referring to FIG. 9, a wider UL/DL bandwidth may be supported in a manner of collecting a plurality of UL/DL component carriers (CCs). A technology of collecting and using a plurality of the component carriers is referred to as a carrier aggregation or bandwidth aggregation. A component carrier can be comprehended as a carrier frequency (or center carrier, center frequency) for a corresponding frequency block. Each of a plurality of the component carriers can be adjacent or non-adjacent to each other in frequency domain. A bandwidth of each component carrier can be independently determined. It may configure an asymmetrical carrier aggregation of which the number of UL CCs is different from the number of DL CCs. For instance, there are 2 DL CCs and 1 UL CC, asymmetrical carrier aggregation can be configured in a manner that the DL CC corresponds to the UL CC by 2:1. A link between a DL CC and an UL CC is fixed in a system or can be semi-statically configured. Although a whole system band consists of N number of CCs, a frequency band capable of being monitored/received by a specific user equipment can be restricted to M (≦N) number of CCs. Various parameters for carrier aggregation can be configured by a cell-specific, a UE group-specific or a UE-specific scheme.

Meanwhile, control information can be configured to be transmitted and received on a specific CC only. Such specific CC is referred to as a primary CC (PCC) and the rest of CCs are referred to a secondary CC (SCC). The PCC can be used for a user equipment to perform an initial connection establishment process or a connection re-establishment process. The PCC may correspond to a cell indicated in a handover process. The SCC can be configured after an RRC connection is established and can be used to provide an additional radio resource. As an example, scheduling information can be configured to be transceived via a specific CC only. This sort of scheduling scheme is called cross-carrier scheduling (or cross-CC scheduling). If the cross-CC scheduling is applied, PDCCH for DL assignment is transmitted on a DL CC #0 and corresponding PDSCH can be transmitted on a DL CC #2. The term ‘component carrier’ may be replaced with a different equivalent terminology such as a carrier, a cell or the like. For example, PCC and SCC may be interchangeably used with PCell and SCell, respectively.

For cross-carrier scheduling, a carrier indicator field (CIF) is used. Configuration of the presence or not of the CIF within the PDCCH may be enabled by higher layer signaling (for example, RRC signaling) semi-statically and user equipment-specifically (or user equipment group-specifically). The base line of PDCCH transmission may be summed up as follows.
CIF disabled: the PDCCH on the DL CC allocates PDSCH resource on the same DL CC or PUSCH resource on one linked UL CC.
No CIF
CIF enabled: the PDCCH on the DL CC may allocate PDSCH or PUSCH resource on one DL/UL CC of a plurality of aggregated DL/UL CCs by using the CIF.
LTE DCI format extended to have CIF
CIF (if configured) is a fixed x-bit field (for example, x=3)
CIF (if configured) location is fixed regardless of DCI format size.

If the CIF exists, the base station may allocate a PDCCH monitoring DL CC (set) to reduce complexity of blind detection in view of the user equipment. For PDSCH/PUSCH scheduling, the user equipment may detect and decode the PDCCH on the corresponding DL CC only. Also, the base station may transmit the PDCCH through monitoring DL CC (set) only. The monitoring DL CC set may be configured user equipment-specifically, user equipment group-specifically or cell-specifically.

FIG. 10 illustrates that three DL CCs are aggregated and DL CC A is set to a monitoring DL CC. If the CIF is disabled, each DL CC may transmit the PDCCH that schedules a PDSCH of each DL CC without CIF in accordance with the LTE PDCCH rule. On the other hand, if the CIF is enabled by higher layer signaling, only the DL CC A may transmit the PDCCH, which schedules the PDSCH of another CC as well as the PDSCH of the DL CC A, by using the CIF. The PDCCH is not transmitted from the DL CC B and DL CC C which are not set to the PDCCH monitoring DL CC.

A PDCCH having a CIF is transmitted through a UE-specific search space (USS). Thus, in case that a UE receives information indicating CIF-enabled through a higher-layer signal, the UE may monitor the UE-specific search space and receive downlink control information for cross-carrier scheduling. On the other hand, a PDCCH without a CIF is transmitted through a common search space (CSS). Thus, a UE may monitor the common search space for the PDCCH without a CIF and received the corresponding downlink control information. Since a PDCCH for PMCH change notification is transmitted/received through a CSS, the PDCCH does not have a CIF.

In a Rel-10/11-based legacy LTE-A system supporting carrier aggregation (CA) of a plurality of cells, MBMS has a structure that control signaling such as PMCH (carrying multicast data, control information-related logical channel (i.e., MTCH), MCCH, etc.), PDCCH (e.g., PDCCH masked with M-RNTI) indicating the changes of system information (or, SIB) (e.g., SIB13) for setting various control information/parameters (e.g., (MBSFN) transmission SF and period) necessary for transmitting the PMCH and specific information/parameter (e.g., contents included in MCCH) is transmitted according to a cell. For example, when two cells (cell 1 and cell 2) are carrier aggregated, SIB for controlling PMCH transmitted on the cell 1 and PDCCH can be transmitted via a CSS (common search space) on the cell 1 and/or PDSCH scheduled from the CSS and SIB for controlling PMCH transmitted on the cell 2 and PDCCH can be transmitted via a CSS on the cell 2 and/or corresponding PDSCH, respectively. Hence, in order for a UE of which Pcell and Scell are carrier aggregated (CA) to receive MBMS from both the Pcell and the Scell, it may be additionally required to have capability capable of performing blind decoding on CSS on the Pcell and CSS on the Scell at the same time (in the aspect of UE implementation).

Meanwhile, in a legacy system, PDCCH masked with M-RNTI (for clarity, “M-PDCCH”) is used for an MCCH change notification usage and subframe (SF) information for monitoring (receiving/detecting) the M-PDCCH is configured by SIB13. In the legacy system, the M-PDCCH monitoring subframe (SF) is designated by one of subframes configured as MBSFN. And, the M-PDCCH is configured or transmitted based on a DCI format 1C. Specifically, if an 8-bit bitmap is configured in the DCI format 1C, it may be able to individually indicate whether or not MCCH is changed in response to each of (maximum) 8 MBMS service areas.

Meanwhile, it may consider introducing a carrier dedicatedly used for MBMS (hereinafter, a dedicated MBMS carrier (or an MBMS dedicated carrier) or a dMBMS carrier) in a future system appearing after the LTE-A system to reduce constraints related to MBMS transmission on a carrier according to a legacy LTE-A system (hereinafter, a legacy carrier). For example, the constraints related to the MBMS transmission on the legacy carrier can include a constraint on a subframe resource capable of being configured for MBSFN usage (e.g., except for subframe 0/4/5/9 in FDD), a constraint on a symbol resource capable of being used for transmitting an MBMS signal in an MBSFN subframe (e.g., except for a first symbol and a second symbol), and a constraint on MBMS coverage for maintaining compatibility with a UE according to a legacy LTE-A system (e.g., using extended CP only), and the like. In order to support a type of the MBMS dedicated carrier and reduce complexity according to the decoding burden of a UE, it may consider a method of transmitting the SIB and/or the PDCCH for MBMS transmission-related control signaling of a specific cell (e.g., Scell) via a different cell (e.g., Pcell) (cross-CC) in carrier aggregation (CA) situation.

Hence, the present invention proposes an M-PDCCH transmission (i.e., MCCH change notification) method for efficiently supporting MBMS transmission in carrier aggregation (CA) situation among a plurality of cells. For clarity, in the aspect of CA, a Scell to which MBMS transmission is configured or an MBMS-dedicated carrier (dMBMS carrier) is commonly referred to as ‘non-Pcell’”. The method proposed in the present invention can be classified into 1) a method of transmitting M-PDCCH corresponding to MBMS transmission on a non-Pcell via a Pcell (cross-CC) and 2) a method of transmitting M-PDCCH corresponding to MBMS transmission on a non-Pcell (e.g., dMBMS carrier) via the non-Pcell itself (self-CC). In the present invention, the Pcell and the non-Pcell can be generalized to a cell 1 and a cell 2, respectively.

Approach 1: Cross-CC M-PDCCH from Pcell

In the approach 1 according to the present invention, methods of performing cross-CC transmission of M-PDCCH corresponding to MBMS transmission on a non-Pcell via Pcell are proposed.

Solution 1-1: TDM (Time Division Multiplexing) with M-PDCCH for Pcell and M-PDCCH for Non-Pcell

The solution 1-1 according to the present invention corresponds to a method of differently configuring a subframe in which M-PDCCH for non-Pcell is transmitted and a subframe in which M-PDCCH for Pcell is transmitted (on Pcell). Specifically, among MBSFN subframes (set to Pcell), a specific subframe, which is not configured as M-PDCCH transmission for Pcell, can be configured as M-PDCCH transmission subframe for non-Pcell.

Or, in order to prevent configuring a wasteful MBSFN subframe configuration configured to perform M-PDCCH transmission for non-Pcell, it may be able to differently configure M-PDCCH transmission subframe for non-Pcell and M-PDCCH transmission subframe for Pcell in a set of subframes including all MBSFN subframes and all normal subframes not configured as MBSFN or a specific part of the normal subframes. Or, a specific normal subframe can be configured as M-PDCCH transmission subframe for non-Pcell in a state that M-PDCCH transmission subframe for Pcell is configured as a specific MBSFN subframe.

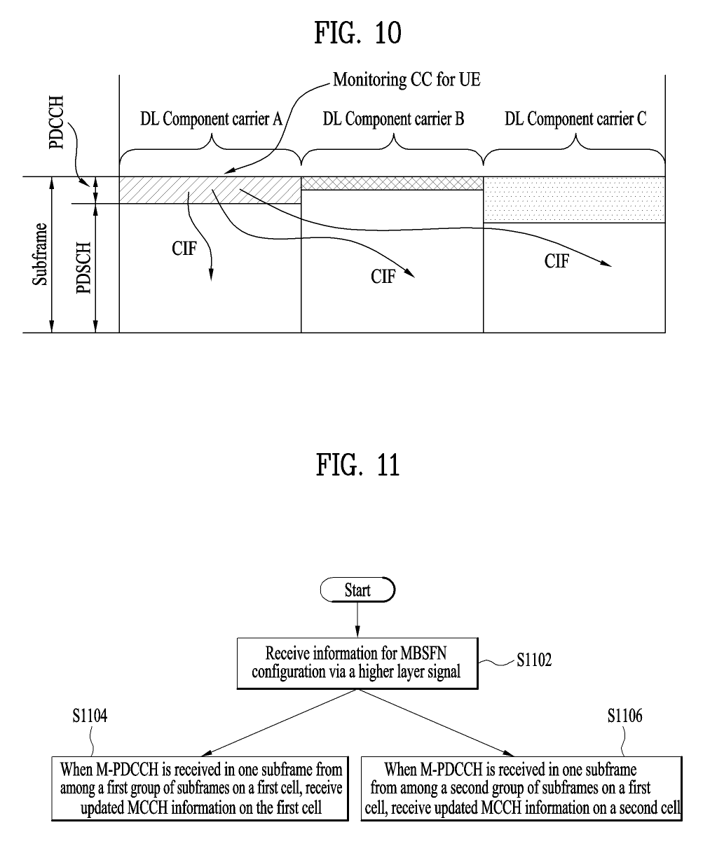

FIG. 11 is an example of a flowchart for a method of receiving control information for a broadcast/multicast service according to the method 1-1. In the example of FIG. 11, a UE assumes that a plurality of cells including a first cell and a second cell are carrier aggregated. The broadcast/multicast service may correspond to MBMS (multimedia broadcast multicast service) transmitted/received via MBSFN. And, the UE assumes that system information (e.g., SIB13) for the broadcast/multicast service has been received.

In the step S1102, the UE can receive information for MBSFN configuration via a higher layer signal (e.g., RRC message). The information for MBSFN configuration can include information indicating an MBSFN subframe. For example, the information for MBSFN configuration can include allocation period information of a radio frame including an MBSFN subframe and offset information specifying a start position of a radio subframe including an MB SFN subframe. And, the information for MBSFN configuration can further include information indicating a specific subframe as an MBSFN subframe in a radio frame determined by the allocation period information and the offset information. And, in order to support the method 1-1 according to the present invention, the information for MBSFN configuration can further include information indicating subframes of a first group and subframes of a second group in an MBSFN subframe. Or, the information indicating the subframes of the first group and the information indicating the subframes of the second group can be received via a separate higher layer signal irrespective of the information for MBSFN configuration.

In the step S1104, the UE can receive PDCCH for MCCH change notification in the MBSFN subframe on a first cell. In this case, the UE can decode PDCCH scrambled or masked with MBMS-specific identification information (e.g., M-RNTI). If the UE receives PDCCH for MCCH change from one of the subframes of the first group in the MBSFN subframe configured in the step S1102, the UE can receive updated MCCH information on the first cell. The PDCCH can be repeatedly/periodically transmitted/received according to MCCH repetition period within MCCH modification period and the updated MCCH information can be repeatedly/periodically transmitted/received according to the MCCH repetition period from MCCH modification period boundary immediately after the MCCH modification period during which the PDCCH is received.

In the step S1106, if the UE receives PDCCH for MCCH change from one of the subframes of the second group within the MBSFN subframe configured in the step S1102, the UE can receive updated MCCH information on the second cell.

Solution 1-2: Setting Different M-RNTI to M-PDCCH for Pcell and M-PDCCH for Non-Pcell

The solution 1-2 according to the present invention corresponds to a method of differently configuring an M-RNTI value used for M-PDCCH scrambling for non-Pcell and an M-RNTI value used for M-PDCCH scrambling for Pcell. In this case, an M-PDCCH monitoring subframe can be configured by one of subframes configured as MBSFN (common to Pcell and non-Pcell).

FIG. 12 is an example of a flowchart for a method of receiving control information for a broadcast/multicast service according to the method 1-2. In the example of FIG. 12, a UE assumes that a plurality of cells including a first cell and a second cell are carrier aggregated. The broadcast/multicast service may correspond to MBMS (multimedia broadcast multicast service) transmitted/received via MBSFN. And, the UE assumes that system information (e.g., SIB13) for the broadcast/multicast service has been received.

In the step S1202, the UE can perform the operations mentioned earlier with reference to the step S1102.

In the step S1204, the UE can receive PDCCH for MCCH change notification in the MBSFN subframe configured in the step S1202. In this case, if PDCCH decoded by the UE is masked or scrambled with a first M-RNTI, the UE can receive updated MCCH information on a first cell. The PDCCH can be repeatedly/periodically transmitted/received according to MCCH repetition period within MCCH modification period and the updated MCCH information can be repeatedly/periodically transmitted/received according to the MCCH repetition period from MCCH modification period boundary immediately after the MCCH modification period during which the PDCCH is received.

In the step S1206, if the PDCCH, which is decoded by the UE in the MBSFN subframe configured in the step S1102, is masked or scrambled with a second M-RNTI, the UE can receive updated MCCH information on the second cell.

In the method 1-2, a plurality of M-RNTIs including the first M-RNTI and the second M-RNTI can be defined in advance, can be received via the information for MBSFN configuration (refer to the step S1102), or can be received via specific system information (e.g., SIB13).

Solution 1-3: Signaling Cell Indicator (CI) Via DCI Format 1C

The solution 1-3 according to the present invention corresponds to a method of signaling a cell indicator (CI) indicating MCCH change notification for MBMS transmission of a cell (e.g., Nell or non-Pcell) signaled by M-PDCCH of DCI format 1C. In the solution 1-3, the number of bits constructing the CI and a CI value corresponding to each cell can be configured in advance via specific system information (e.g., SIB3) (in consideration of a plurality of cells/carriers).

FIG. 13 is an example of a flowchart for a method of receiving control information for a broadcast/multicast service according to the method 1-3. The assumption on FIG. 11 can also be applied to the example of FIG. 13.

In the step S1302, the UE can perform the operations mentioned earlier with reference to the step S1102. In the step S1304, the UE can receive PDCCH for MCCH change notification in the MBSFN subframe configured in the step S1302.

In the step S1306, the UE obtains a cell indicator from the DCI information (e.g., DCI format 1C) included in the PDCCH received in the step S1304 and may be able to receive updated MCCH information on a cell indicated by the obtained cell indicator. For example, if the cell indicator indicates a first cell, the UE receives the updated MCCH information on the first cell. If the cell indicator indicates a second cell, the UE can receive the updated MCCH information on the second cell.

Meanwhile, a size of the DCI format 1C varies according to a system bandwidth (BW). More specifically, the size of the DCI format 1C varies according to a size of a very compact resource block (RB) allocation field that is used for scheduling and varies according to a system bandwidth. If the size of the DCI format 1C varies, it may be able to signal the cell indicator (CI) using one of methods described in the following.

Alt 1) It may be able to use a reserved bit irrespective of a bitmap for indicating whether or not there is MCCII change per MBMS area. For example, when a system bandwidth of Pcell is equal to or greater than the specific number of RBs, the Alt 1 can be used.

Alt 2) It may be able to perform signaling by borrowing a part of a bitmap (and/or a reserved bit). For example, when a system bandwidth of Pcell is less than the specific number of RBs, the Alt 2 can be used. In case of the Alt 2, the (maximum) number of MBMS areas capable of being supported can be designated to be identical to the number of bits remained after being borrowed for the CI usage in the bitmap. And, the number of reserved bits used for the CI and/or the number of bits borrowed from a bitmap used for a MCCH change notification can be signaled in advance (via SIB, and the like).

As a different solution, when a system bandwidth of Pcell is less than the specific number of RBs, it may be able to restrict cross-CC transmission for M-PDCCH not to be supported from the Pcell.

Solution 1-4: Use DCI Format 1a for Non-Pcell

The solution 1-4 according to the present invention corresponds to a method of configuring/transmitting M-PDCCH for non-Pcell using a DCI format 1A (and M-RNTI-based scrambling). In this case, similar to the legacy method, it may be able to use the DCI format 1C for Pcell. Hence, M-PDCCH transmission for the Pcell and M-PDCCH transmission for the non-Pcell can be distinguished from each other by using a DCI format including a different size.

FIG. 14 is an example of a flowchart for a method of receiving control information for a broadcast/multicast service according to the method 1-4. The assumption on FIG. 11 can also be applied to the example of FIG. 14.

In the step S1402, the UE can perform the operations mentioned earlier with reference to the step S1102. In the step S1404, the UE can receive PDCCH for MCCH change notification in the MBSFN subframe configured in the step S1402.

In the step S1406, the UE can receive updated MCCH information on a cell corresponding to a type or a size of DCI information included in the PDCCH received in the step S1404. For example, if the PDCCH received in the step S1404 corresponds to the DCI format 1A, it may be able to receive updated MCCH information on a second cell. As a different example, if the PDCCH received in the step S1404 corresponds to a size of the DCI format 1C, the UE receives updated MCCH information on a first cell. If the PDCCH received in the step S1404 is greater than the size of the DCI format 1C, the UE can receive the updated MCCH information on the second cell.

As a different embodiment of the solution 1-4, it may consider a method of configuring/transmitting M-PDCCH for both Pcell and non-Pcell using the DCI format 1A. In this case, a bitmap for notifying MCCH change per MBMS area can be individually/independently configured for the Pcell and the non-Pcell, respectively, in the DCI format 1A. Or, similar to the solution 1-3, it may be able to signal CI in the DCI format 1A to indicate a cell in which a bitmap for notifying MCCH change per MBMS area is used.

Solution 1-5: Configuring Bitmap for a Plurality of Cells

The solution 1-5 according to the present invention corresponds to a method of configuring each of bits constructing a bitmap for notifying MCCH change in M-PDCCH (without additional CI signaling) to indicate whether or not there is MCCH change for MBMS area of a cell/carrier (via SIB, and the like).

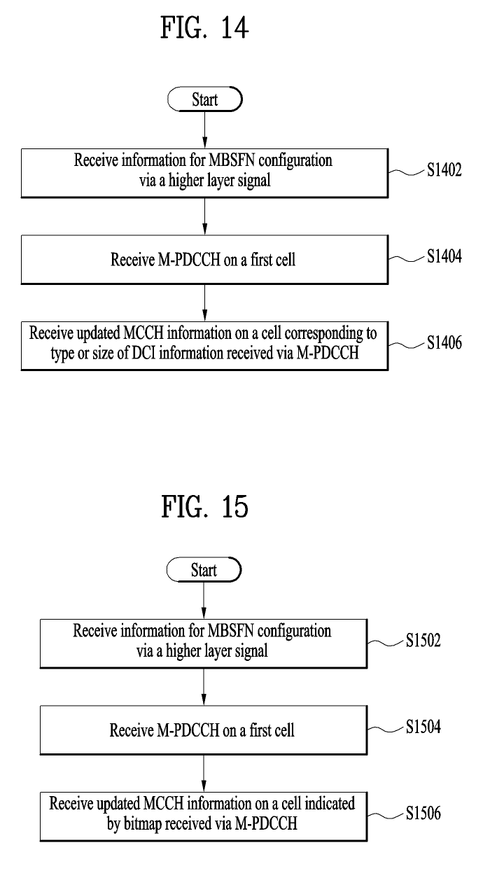

FIG. 15 is an example of a flowchart for a method of receiving control information for a broadcast/multicast service according to the method 1-5. The assumption on FIG. 11 can also be applied to the example of FIG. 15.

In the step S1502, the UE can perform the operations mentioned earlier with reference to the step S1102. In the step S1504, the UE can receive PDCCH for MCCH change notification in the MBSFN subframe configured in the step S1502.

In the step S1506, the UE can receive bitmap information via DCI information (e.g., DCI format 1C) included in the PDCCH received in the step S1504. Each bit of the bitmap information corresponds to a specific cell. If a bit is set to a specific value (e.g., 1), the UE can receive updated MCCH information on a cell corresponding to the bit. For example, a mapping relationship between a bit and a cell in the bitmap information can be configured in advance in a manner that a bit number of the bitmap information corresponds to a cell index. As a different example, a mapping relationship between a bit and a cell in the bitmap information can be defined in advance according to a specific order. As a further different example, a mapping relationship between a bit and a cell in the bitmap information can be configured in advance via a higher layer signal (e.g., RRC message) or system information.

Meanwhile, the solutions 1-1, 1-2, 1-4, and 1-5 according to the present invention can be applied not only as a scheme of distinguishing Pcell from non-Pcell but also as a scheme of distinguishing a plurality of non-Pcells. And, the solution 1-3 according to the present invention can be applied as a scheme of distinguishing a plurality of non-Pcells in a state that Pcell and non-Pcell are previously distinguished from each other based on other solutions (e.g., methods 1-1, 1-2, 1-4, 1-5, etc.).

Approach 2: Self-CC M-PDCCH on Non-Pcell

In the approach 2 according to the present invention, solutions for performing self-CC transmission of M-PDCCH corresponding to MBMS transmission on a non-Pcell via the non-Pcell are proposed.

Solution 2-1: Using First Several Symbols

The solution 2-1 according to the present invention corresponds to a method of transmitting M-PDCCH for non-Pcell using one or more symbols (e.g., 1 or 2 symbols) including a lowest index in MBSFN subframe on a non-Pcell (e.g., dMBMS carrier). The solution 2-1 may be appropriate for a case that a period in which the symbol is transmitted (e.g., on a dMBMS carrier) follows a form (e.g., accompanied with CRS transmission) similar to MBSFN subframe on a legacy carrier.

Meanwhile, in case of the dMBMS carrier, it may be not necessary to perform PDCCH transmission for a different usage or purpose except M-PDCCH transmitted for notifying MCCH change. Hence, the M-PDCCH can be deterministically configured/transmitted/received via a predetermined resource (e.g., resource element) without configuring/accompanying a separate PDCCH search space (e.g., CSS) (and blind decoding on the separate PDCCH search space).

In the solution 2-1 according to the present invention, a (predetermined) resource used for transmitting M-PDCCH can be configured by one of methods described in the following.

Alt 2-1) It may be able to configure the resource used for transmitting M-PDCCH to be identical to a resource that configures a specific PDCCH candidate index including a specific CCE aggregation level (e.g., 8) belonging to a legacy CSS in consideration of complexity of UE implementation.

Alt 2-2) It may be able to configure a new form that uses resources most adjacent to a resource for transmitting CRS to secure stable transmission and reception capability.

And, the resource used for transmitting M-PDCCH can be changed in a subframe unit or a subframe group unit (e.g., hopping). For example, in case of the Alt 2-1, an index of a corresponding CSS PDCCH candidate can be changed in the subframe unit or the subframe group unit. In order to control M-PDCCH transmission coverage and interference impact, (one) M-PDCCH transmission resource can be configured/transmitted in response to a plurality (e.g., 2) of different coding rates (e.g., CCE aggregation level 4/8).

Solution 2-2: Transmission within PMCH Region

The solution 2-2 according to the present invention corresponds to a method of transmitting M-PDCCH for non-Pcell using a specific resource (e.g., resource element (RE) belonging to a symbol area/period in which PMCH is transmitted in MBSFN subframe on the non-Pcell (e.g., dMBMS carrier). The solution 2-2 may be suitable for a case that MBSFN subframe is configured without a symbol period similar to a legacy symbol period (e.g., accompanied with CRS transmission) (on a dMBMS carrier) or PMCH is transmitted using the whole of symbols in a corresponding subframe.

In this case, it may use MBSFN reference signal (RS) to receive/demodulate/detect M-PDCCH and it may be able to configure M-PDCCH transmission resource using resources most adjacent to MBSFN RS transmission resource to stably perform transmission and reception. If the M-PDCCH and the PMCH are transmitted at the same time via an identical subframe, the PMCH can be transmitted using the remaining resource only except the resource used for transmitting the M-PDCCH (by applying rate-matching or puncturing).

Solution 2-3: Transmit Through Normal Subframe

The solution 2-3 according to the present invention corresponds to a method of transmitting M-PDCCH for non-Pcell via a normal subframe (not configured as MBSFN subframe). The solution 2-3 may be appropriate for a case that inversely configuring a normal subframe on dMBMS carrier is available. In this case, it may be able to apply a scheme of transmitting/detecting M-PDCCH similar to a scheme on a legacy carrier. For example, if M-PDCCH is transmitted via one of PDCCH candidates belonging to a common search space (CSS), a UE can detect the M-PDCCH by performing blind decoding on the CSS.

Meanwhile, in the solution 2-3, a normal subframe capable of being exceptionally configured on the dMBMS carrier may correspond to a subframe configured to transmit system/common information on the carrier itself and MBMS transmission-related information (e.g., PBCH/SIB) and/or a subframe configured to schedule/transmit UE-specific PDSCH.

Meanwhile, the solutions (e.g., solution 1-1, solution 1-2, and solution 1-3) proposed in the present invention can also be similarly applied to a situation that specific SIB for non-Pcell and PDCCH for scheduling the specific SIB are configured to perform cross-CC transmission in the Pcell instead of the non-Pcell. For example, the specific SIB corresponds to SIB including information/parameter related to MBMS transmission on the non-Pcell and the PDCCH may correspond to SI-RNTI-based PDCCH.

Meanwhile, in order to perform cross-CC scheduling on the specific SIB for non-Pcell (non-Pcell-dedicated SIB or non-Pcell dSIB) on the Pcell, it may be able to use a different method. For example, the non-Pcell dSIB is transmitted based on information/parameter necessary for transmitting/receiving the non-Pcell dSIB in a state that the information/parameter is signaled/configured via a specific SIB (e.g., SIB 1), which is transmitted prior to the non-Pcell dSIB (via the Pcell). The information/parameter can be transmitted in a PDSCH form not accompanied with corresponding (i.e., scheduling the SIB) PDCCH transmission. In this case, for example, the information/parameter necessary for transmitting/receiving the non-Pcell dSIB can include timing/period information on a subframe capable of transmitting the SIB, allocation of a resource block (RB) configuring DCI for scheduling the SIB transmission, modulation and coding scheme (MCS) index, transport block (TB) size, and the like.

As a further different method, in a state that the timing/period information on the subframe capable of transmitting non-Pcell SIB is signaled/configured via a specific SIB (e.g., SIB1) which is transmitted via the Pcell prior to the non-Pcell dSIB, the non-Pcell dSIB and PDCCH for scheduling the non-Pcell dSIB can be transmitted via the non-Pcell itself based on the configured subframe timing/period. Or, the PDCCH for scheduling the non-Pcell dSIB is transmitted via the Pcell and the non-Pcell dSIB itself can be transmitted via the non-Pcell.

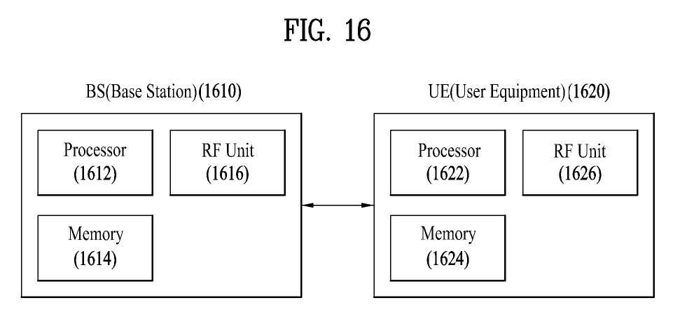

FIG. 16 is a diagram illustrating a base station and a user equipment to which the present invention is applicable.

Referring to FIG. 16, a wireless communication system includes the BS 1610 and the UE 1620. When the wireless communication system includes a relay, the BS 1610 or the UE 1620 may be replaced with the relay.

The BS 1610 includes a processor 1612, a memory 1614, and a radio frequency (RF) unit 1616. The processor 1612 may be configured to embody the procedures and/or methods proposed by the present invention. The memory 1614 is connected to the processor 1612 and stores various pieces of information associated with an operation of the processor 1612. The RF unit 1616 is connected to the processor 1612 and transmits/receives a radio signal. The UE 1620 includes a process 1622, a memory 1624, and an RF unit 1626. The processor 1622 may be configured to embody the procedures and/or methods proposed by the present invention. The memory 1624 is connected to the processor 1622 and stores various pieces of information associated with an operation of the processor 1622. The RF unit 1626 is connected to the processor 1622 and transmits/receives a radio signal.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

Specific operations to be conducted by the base station in the present invention may also be conducted by an upper node of the base station as necessary. In other words, it will be obvious to those skilled in the art that various operations for enabling the base station to communicate with the terminal in a network composed of several network nodes including the base station will be conducted by the base station or other network nodes other than the base station.

The embodiments of the present invention may be implemented by various means, for example, hardware, firmware, software, or a combination thereof. In a hardware implementation, an embodiment of the present invention may be implemented by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software implementation, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention is applicable to a wireless communication apparatus such as a user equipment (UE), a base station (BS), etc.

What is claimed is:

1. A method for receiving control information for MBMS (Multimedia Broadcast Multicast Service) in a wireless communication system supporting carrier aggregation of a plurality of cells comprising a first cell and a second cell, the method comprising:
receiving information for MBSFN (Multicast Broadcast Single Frequency Network) configuration via higher layer signaling, wherein the information comprises information indicating MBSFN subframes, information indicating a first group of subframes within the MBSFN subframes, and information indicating a second group of subframes within the MBSFN subframes;
when a PDCCH for notifying a change of an MCCH (Multicast Control Channel) is received in one subframe of the first group of subframes on the first cell, receiving updated MCCH information via a PMCH (Physical Multicast Channel) on the first cell; and
when a PDCCH for notifying a change of an MCCH is received in one subframe of the second group of subframes on the first cell, receiving updated MCCH information via PMCH on the second cell.

2. The method according to claim 1, wherein the plurality of cells further comprise a third cell,
wherein the information for MBSFN configuration further comprises information indicating a third group of subframes within the MBSFN subframes, and
wherein the method further comprises:
when a PDCCH for notifying a change of an MCCH is received in one subframe of the third group of subframes on the first cell, receiving data via a PMCH on the third cell.

3. The method according to claim 1, wherein the PDCCH received on the first cell and the PDCCH received on the second cell are scrambled using different MBMS-specific identification information.

4. The method according to claim 1, wherein the updated MCCH information comprises an RRC (Radio Resource Configuration) message for configuring a single MBSFN region, and the RRC message comprises a list of all MBMS services in progress.

5. The method according to claim 1, wherein the PDCCH is periodically and repeatedly transmitted with a second period in a first period.

6. The method according to claim 1, wherein when the wireless communication system operates in FDD (Frequency Division Duplex), the MBSFN subframes are configured from among subframes other than subframes 0, 4, 5, and 9 in a radio frame, and
wherein when the wireless communication system operates in TDD (Time Division Duplex), the MBSFN subframes are configured from among subframes other than subframes 0, 1, 2, 5, and 6 in a radio frame.

7. A user equipment operating in a wireless communication system supporting carrier aggregation of a plurality of cells comprising a first cell and a second cell, the user equipment comprising:
an RF (radio frequency) unit; and
a processor operably connected to the RF unit and configured to:
control the RF unit to receive information for MBSFN (Multicast Broadcast Single Frequency Network) configuration via higher layer signaling, wherein the information comprises information indicating MBSFN subframes, information indicating a first group of subframes within the MBSFN subframes, and information indicating a second group of subframes within the MBSFN subframes,
when a PDCCH for notifying a change of an MCCH (Multicast Control Channel) is received in one subframe of the first group of subframes on the first cell, control the RF unit to receive updated MCCH information via a PMCH (Physical Multicast Channel) on the first cell, and
when a PDCCH for notifying a change of an MCCH is received in one subframe of the second group of subframes on the first cell, control the RF unit to receive updated MCCH information via a PMCH on the second cell.

8. The user equipment according to claim 7, wherein the plurality of cells further comprise a third cell,
wherein the information for MBSFN configuration further comprises information indicating a third group of subframes within the MBSFN subframes, and
wherein when a PDCCH for notifying a change of an MCCH is received in one subframe of the third group of subframes on the first cell, the user equipment is configured to control the RF unit to receive data via a PMCH on the third cell.

9. The user equipment according to claim 7, wherein the PDCCH received on the first cell and the PDCCH received on the second cell are scrambled using different MBMS-specific identification information.

10. The user equipment according to claim 7, wherein the updated MCCH information comprises an RRC (Radio Resource Configuration) message for configuring a single MBSFN region, and the RRC message comprises a list of all MBMS services in progress.

11. The user equipment according to claim 7, wherein the PDCCH is periodically and repeatedly transmitted with a second period in a first period.

12. The user equipment according to claim 7, wherein when the wireless communication system operates in FDD (Frequency Division Duplex), the MBSFN subframes are configured from among subframes other than subframes 0, 4, 5, and 9 in a radio frame, and
wherein when the wireless communication system operates in TDD (Time Division Duplex), the MBSFN subframes are configured from among subframes other than subframes 0, 1, 2, 5, and 6 in a radio frame.
